(19) United States
(12) Patent Application Publication
(10) Pub. No.: US 2026/0017469 A1
(43) Pub. Date: Jan. 15, 2026

(54) ZERO-SHOT LANGUAGE SOLVER FUELED BY VISUAL IMAGINATION

(71) Applicant: TENCENT AMERICA LLC, Palo Alto, CA (US)

(72) Inventors: Wenlin YAO, College Station, TX (US); Hongming ZHANG, Palo Alto, CA (US); Xiaoyang WANG, Palo Alto, CA (US); Dong YU, Palo Alto, CA (US); Jianshu CHEN, Palo Alto, CA (US); Yue YANG, Shenzhen (CN)

(73) Assignee: TENCENT AMERICA LLC, Palo Alto, CA (US)

(21) Appl. No.: 19/330,245

(22) Filed: Sep. 16, 2025

Related U.S. Application Data
(63) Continuation of application No. 18/077,693, filed on Dec. 8, 2022, now Pat. No. 12,468,896.

(51) Int. Cl. G06F 40/40

(52) U.S. Cl. CPC G06F 40/40

(57) ABSTRACT

A language processing method performed by at least one processor includes receiving a task input stream and a solution input stream; selecting one of the task input stream and the solution input stream, and providing the selected stream to an image conversion model; creating, based on the selected input stream, a model ensemble of the image conversion model and the language model; and outputting a prediction based on the model ensemble.

### CROSS-REFERENCE TO RELATED APPLICATION

This application is a Continuation of U.S. application Ser. No. 18/077,693, filed Dec. 8, 2022, in the U.S. Patent and Trademark Office, which is incorporated herein by reference in its entirety.

### FIELD

The disclosure generally relates to natural language processing and classification.

### BACKGROUND

Natural language processing is used to convert unformatted language inputs into data understandable by a computational device, which can then leverage its processing capabilities to respond to or otherwise solve the input(s).

Large-scale pretrained language models (PLMs) have achieved great success on various natural language understanding (NLU) tasks and even exhibit impressive zero-shot capabilities without task-specific fine-tuning. Recent research suggests that this ability improves by further scaling up the model size (e.g., to hundreds of billions of parameters) and the amount of textual pre-training data (e.g., to terabytes of raw text).

However, zero-shot language learners solely trained on text inevitably suffer from human reporting bias. For example, people tend not to write about common or obvious facts, and the frequency of a given textual statement does not always correspond to its relative likelihood in the real world. Therefore, supplementing textual information with other modalities is crucial.

### SUMMARY

The following presents a simplified summary of one or more embodiments of the present disclosure to provide a basic understanding of such embodiments. This summary is not an extensive overview of all contemplated embodiments and is intended neither to identify key or critical elements of all embodiments nor to delineate the scope of any or all embodiments. Its sole purpose is to present some concepts of one or more embodiments in a simplified form as a prelude to the more detailed description presented later.

According to an aspect of the disclosure, a language processing method performed by at least one processor includes receiving a task input stream and a solution input stream; selecting one of the task input stream and the solution input stream, and providing the selected stream to an image conversion model; creating, based on the selected input stream, a model ensemble of the image conversion model and the language model; and outputting a prediction based on the model ensemble.

According to an aspect of the disclosure, a language processing apparatus includes at least one memory configured to store program code; and at least one processor configured to read the program code and operate as instructed by the program code, the program code including receiving code configured to cause the at least one processor to receive a task input stream and a solution input stream; selecting code configured to cause the at least one processor to select one of the task input stream and the solution input stream; providing code configured to cause the at least one processor to provide the selected input stream to an image conversion model and a language model; ensembling code configured to cause the at least one processor to create, based on the selected input stream, a model ensemble of the image conversion model and the language model; and outputting code configured to cause the at least one processor to output a prediction based on the model ensemble.

According to an aspect of the disclosure, a non-transitory computer readable medium having instructions stored therein, which when executed by a processor cause the processor to at least receive a task input stream and a solution input stream; select one of the task input stream and the solution input stream; provide the selected input stream to an image conversion model and a language model; create, based on the selected input stream, a model ensemble of the image conversion model and the language model; and output a prediction based on the model ensemble.

Additional embodiments will be set forth in the description that follows and, in part, will be apparent from the description, and/or may be learned by practice of the presented embodiments of the disclosure.

### BRIEF DESCRIPTION OF THE DRAWINGS

Further features, nature, and various advantages of the disclosed subject matter will be more apparent from the following detailed description and the accompanying drawings, in which:

FIG. 1A is a flowchart of an example Z-LaVI natural language processing method, in accordance with various embodiments.

FIG. 1B is a diagram illustrating two exemplary operating modes of the Z-LaVI natural language processing method, in accordance with various embodiments.

FIG. 2 is a block diagram of example components of an image conversion model, in accordance with various embodiments.

FIG. 3A is a flowchart of a language model using prompt-based language inference, in accordance with various embodiments.

FIG. 3B is a flowchart of a language model using natural language inference, in accordance with various embodiments.

FIG. 3C is a flowchart of a language model using latent embedding language inference, in accordance with various embodiments.

FIGS. 4A-4B show two example operations of the Z-LaVI method, in accordance with various embodiments.

FIG. 5 shows four example operations of the Z-LaVI method, in accordance with various embodiments.

FIG. 6 demonstrates the performance advantages of the Z-LaVI method, in accordance with various embodiments.

FIGS. 7A-7C demonstrate the Z-LaVI method solving three different exemplary task types, in accordance with various embodiments.

FIG. 8 is a block diagram of example components of one or more devices, in accordance with various embodiments.

FIG. 9 is a series of tables demonstrating increased importance compared to peer state of the art natural language systems, in accordance with various embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the embodiments to the precise form disclosed. Modifications and variations are possible in light of the above disclosure or may be acquired from practice of the embodiments. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the embodiments. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible embodiments. In fact, many of these features may be combined in ways not specifically recited in the claims and/or disclosed in the specification. Although each dependent claim listed below may directly depend on only one claim, the disclosure of possible embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure define a method for natural language processing and image generation. The embodiments of the present disclosure provide the significantly advantageous features of providing accurate task solutions in a zero-shot environment.

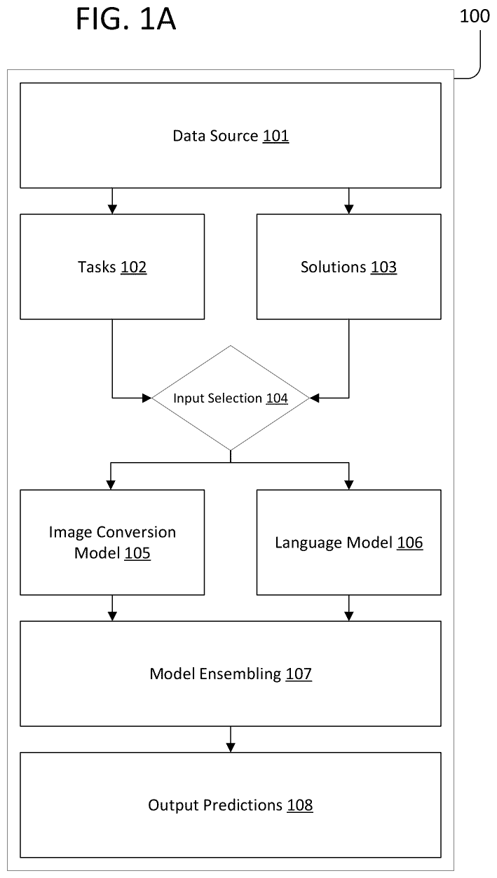

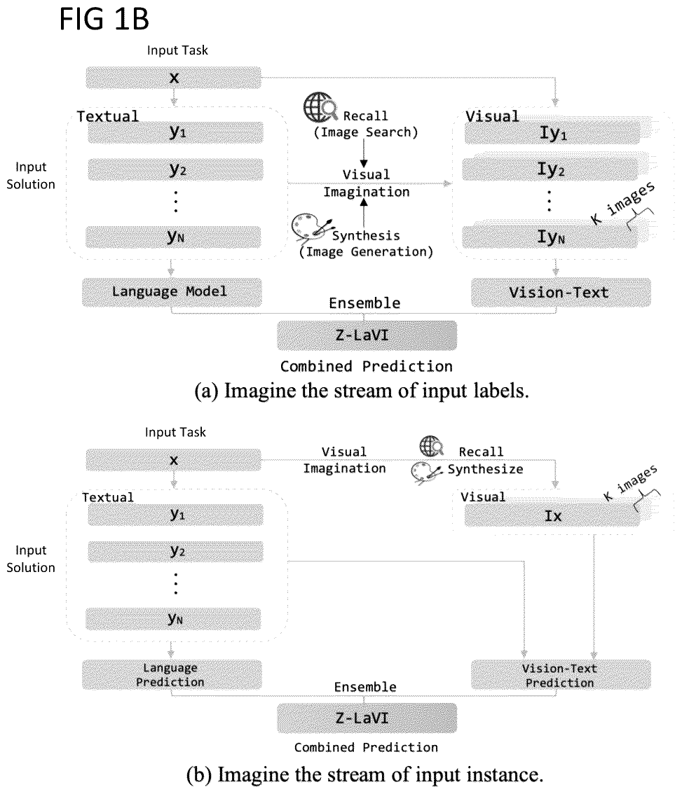

FIGS. 1A-1B illustrate an embodiment of the Z-LaVI natural language processing system 100.

Data Source 101 may include one or more devices capable of receiving, generating, storing, processing, and/or providing information. For example, the data source 101 may include a computing device (e.g., a desktop computer, a laptop computer, a tablet computer, a handheld computer, a smart speaker, a server, etc.), a mobile phone (e.g., a smartphone, a radiotelephone, etc.), a wearable device (e.g., a pair of smart glasses or a smartwatch), or a similar device. In some embodiments, the data source 101 may receive information from and/or transmit information to other devices.

Data Source 101 may include one or more devices as described elsewhere herein. In some embodiments, the data source 101 may include a cloud server or a group of cloud servers. In some embodiments, the Z-LaVI system and its subcomponents 101-108 may be designed to be modular such that software components may be swapped in or out depending on a particular need. As such, the Z-LaVI system may be easily and/or quickly reconfigured for different uses.

In some embodiments, as shown, the system 100 may be hosted in a cloud computing environment. In some embodiments, the system 100 may not be cloud-based (e.g., may be implemented outside of a cloud computing environment) or may be partially cloud-based.

The Data Source 101 provides a stream of Tasks 102 and a stream of Solutions 103 to the system.

In some embodiments, the Tasks 102 may include, but are not limited to, word sense disambiguation, science question answering, topic classification, text classification tasks, image classification tasks, and combinations thereof.

In some embodiments, when the task is a word sense disambiguation task, the Solutions 103 may include all possible senses of a target word in an input sentence, and the system may output a prediction including one or more of the most accurate word senses.

In some embodiments, when the task is a science question answering task, the Solutions 103 may include all answer options for a question, and the system may output a prediction including one or more of the most accurate answers.

In some embodiments, when the task is a text classification task, the Solutions 103 may include all possible categories for a text, and the system may output a prediction including one or more of the most accurate categories.

In some embodiments, Input Selection 104 may choose either the stream of Tasks 102 or the stream of Solutions 103 to provide to the Image Conversion Model 105, the Language Model 106, or both. In some embodiments, Input Selection 104 provides the chosen stream to only the Image Conversion Model 105. FIG. 1B demonstrates one way the system may adapt to the selection of Tasks 102 or Solutions 103.

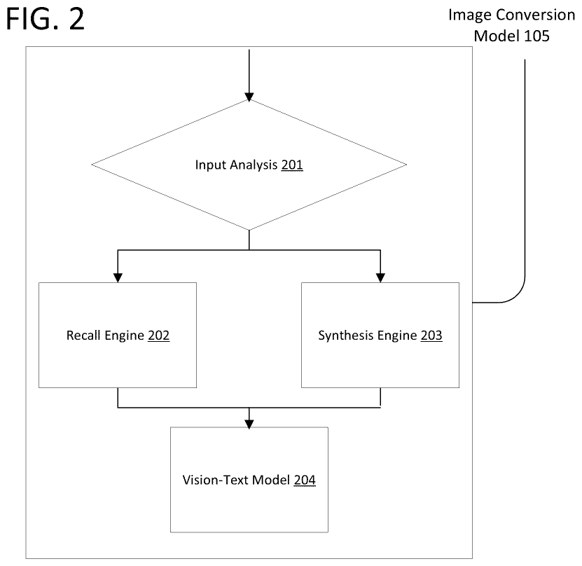

In some embodiments, the Image Conversion Model 105 may generate an image corresponding to the input stream provided by Input Selection 104. An exemplary embodiment of Image Conversion Model 105 is illustrated in FIG. 2. In some embodiments, the Image Conversion Model 105 may perform a step of Synthesis using Synthesis Engine 203 and generate a new image using a text-to-image generation model. In some embodiments, the text-to-image generation model may be a Generative Pre-Trained Transformer (GPT) model. In some embodiments, the text-to-image generation model may be a Contrastive Language-Image Pre-training (CLIP) model.

In some embodiments, the Generative Pre-Trained Transformer model and the Contrastive Language-Image Pre-training model may be used in conjunction. In some embodiments, the Image Conversion Model 105 may use an image quantization model, which may encode an image into lower-dimensional discrete latent codes and may also decode an image. In some embodiments, the Image Conversion Model 105 may use a Bidirectional Encoder Representations from Transformers (BERT) model as an autoregressive transformer. In some embodiments, the Image Conversion Model 105 synthesizes a new image using a generative adversarial network. In some embodiments, Synthesis may be repeated. In some embodiments, Synthesis may be performed by requesting and receiving an image from an external image generator, such as an online image generator.

In some embodiments, the Image Conversion Model 105 may perform a Recall operation using Recall Engine 202. This recall operation may include a search for a preexisting image corresponding to the input stream provided by Input Selection 104. The number of images returned by a search may be limited to a maximum number. If the number of available images is below a certain threshold, the system may download all available images. The search may be performed using an online search engine or a local database of images. The Recall operation may be repeated as needed.

In some embodiments, images from both Recall and Synthesis may be collected into a set of one or more images. A task may then be converted from a language task into a multimodal task using the images, the text, or both. This multimodal task may be provided to a Vision-Text Model 204, which in some embodiments uses a CLIP model.

In some embodiments, the Language Model 106 may receive the input stream provided by Input Selection 104. In some embodiments, the Language Model 106 may receive both the Tasks 102 and the Solutions 103. The Language Model 106 may transform different tasks into multi-choice questions, where an input task $x$ from the stream of Tasks 102 and a candidate solution $y$ from the stream of Solutions 103 are provided.

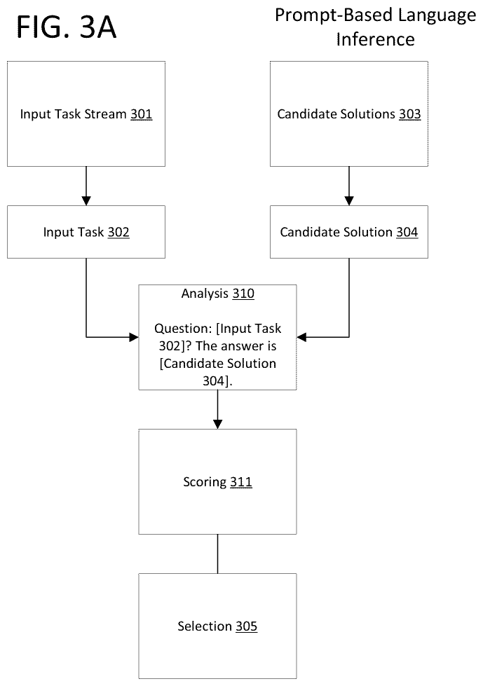

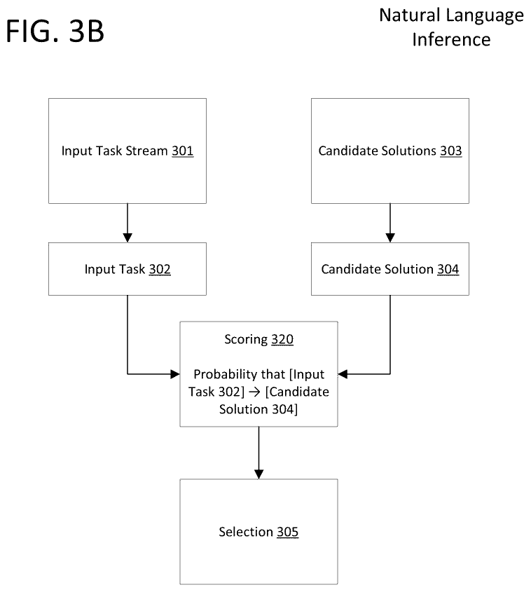

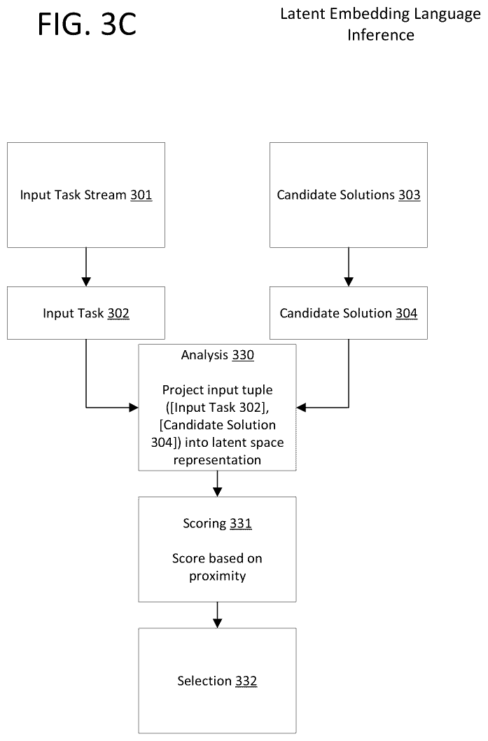

In some embodiments, the Language Model 106 may use a Prompt-based Approach, an example of which is illustrated in FIG. 3A. Input Task Stream 301 may provide Input Task 302, and Candidate Solutions 303 may provide Candidate Solution 304. Analysis 310 may convert the input into a question-answer format, such as ‘Question: [302]? The answer is [304].’ The Language Model 106 may use models such as GPT-Neo-1.3B/2.7B, GPT-J-6B, and OPT-30B. Scoring 311 may use a softmax function or GPT to score Candidate Solution 304. The process of Analysis 310, Scoring 311, and Selection 305 may be repeated for multiple Input Tasks 302 and/or multiple Candidate Solutions 304.

In some embodiments, Selection 305 may select the Candidate Solution 304 that produced the highest score. In other embodiments, Selection 305 may select the Candidate Solution with the lowest score, all solutions with scores above a certain threshold, or all solutions with scores below a certain threshold. The operations of Selection 305, Scoring 311, Scoring 320, and Scoring 331 may be performed based on an analysis of one or more Input Tasks 302, one or more Candidate Solutions 304, or particular combinations thereof.

In some embodiments, the Language Model 106 may use a Natural Language Inference Approach, as illustrated in FIG. 3B. Input Task Stream 301 provides Input Task 302, and Candidate Solutions 303 provides Candidate Solution 304. Scoring 320 is based on the probability that the Input Task 302 logically entails the Candidate Solution 304. In some embodiments, Scoring 320 scores based on the probability that an Input Task 302 logically entails a Candidate Solution 304 such that 302→304. The Language Model 106 may use ROBERTa-large and BART-large models fine-tuned on the Multi-genre NLI (MNLI) corpus.

In some embodiments, the Language Model 106 may use a Latent Embedding Approach, as illustrated in FIG. 3C. Input Task Stream 301 provides Input Task 302, and Candidate Solutions 303 provides Candidate Solution 304. Analysis 330 encodes a given tuple (302, 304) into a shared latent space. Scoring 331 then scores the tuple based on proximity, which can be determined using a cosine similarity score. These scores may be normalized using a softmax function. The Language Model 106 may use Sentence-BERT (SBERT) and SimCSE. In some embodiments, SBERT uses the all-mpnet-base-v2 checkpoint, and SimCSE uses the unsup-simcse-roberta-large model.

In some embodiments, the results of the Image Conversion Model 105 and the Language Model 106 are provided to Model Ensembling 107. The Output Prediction 108 may be determined by summing the predictions of the models or by calculating a weighted sum. The weight may be calibrated based on the relative size of the Language Model 106 and the Vision-Text Model 204.

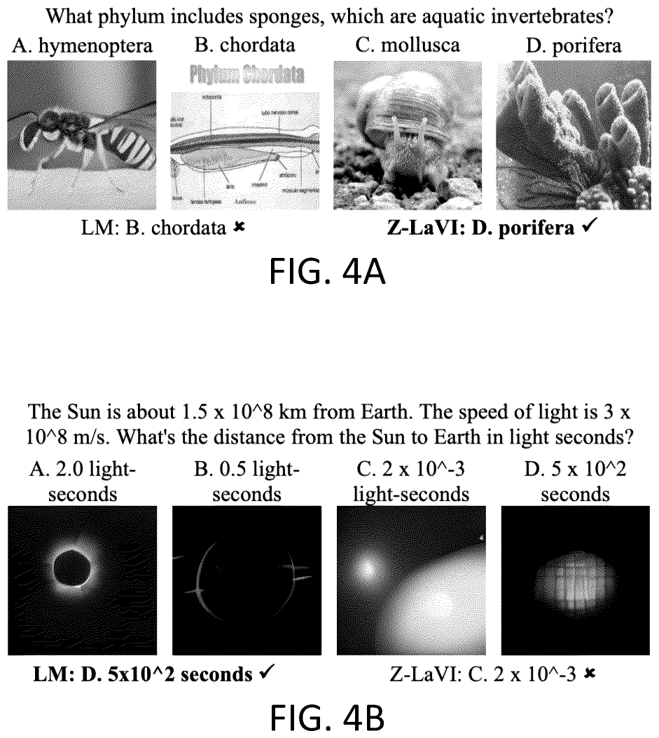

FIG. 4 is an example comparing the performance of one embodiment of the Z-LaVI system to state-of-the-art natural language systems on Science Question Answering Tasks involving biology and mathematics. For example, FIG. 4A shows an embodiment of the Z-LaVI system correctly answering the question “What phylum includes sponges, which are aquatic invertebrates?” after generating images corresponding to “hymenoptera,” “chordata,” “mollusca,” and “porifera.” FIG. 4B shows Z-LaVI incorrectly answering the question “The Sun is about 1.5×10\hat{ }8 km from Earth. The speed of light is 3×10\hat{ }8 m/s. What's the distance from the Sun to Earth in light seconds?” after generating answers corresponding to “2.0 light-seconds,” “0.5 light-seconds,” “2×10\hat{ }−3 light-seconds” and “5×10\hat{ }2 light seconds.”

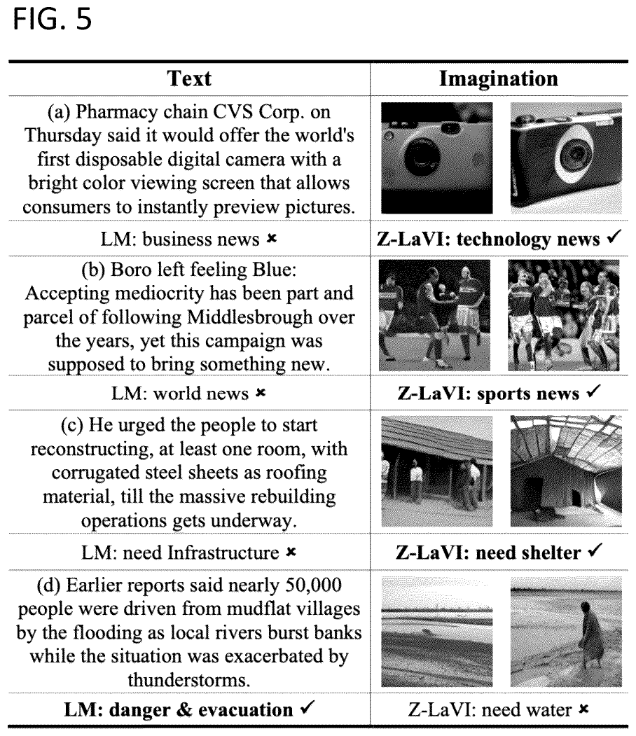

FIG. 5 is an example comparing the performance of one embodiment of the Z-LaVI system to state-of-the-art natural language systems on Text Classification Tasks involving news articles. For example, FIG. 5A shows the Z-LaVI system classifying an article about a digital disposable camera as “technology news,” which an LM-only system misclassified. FIG. 5B shows the Z-LaVI system classifying an article about sports as “sports news,” which the LM-only system misclassified. FIG. 5C shows the Z-LaVI system classifying an article about reconstructing shelter as “needing shelter,” which the LM-only system misclassified. Conversely, FIG. 5D shows the Z-LaVI system incorrectly classifying an article about flooding as “needing water,” a task the LM-only system classified correctly.

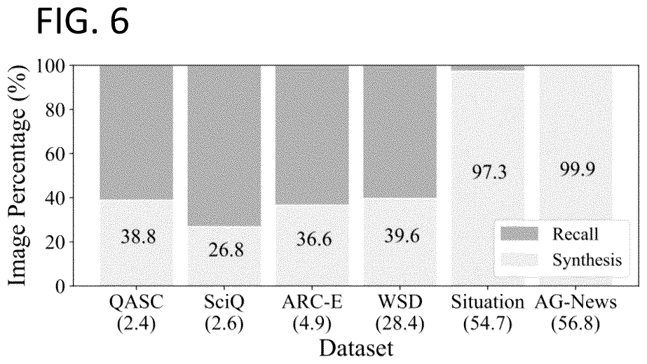

FIG. 6 demonstrates the performance impact of including both Recall and Synthesis in classifying certain datasets. On the AG-News and Situation datasets, the embodiment relied more heavily on synthesizing new images, while on Science Question datasets, the embodiment relied more heavily on Recall, demonstrating the advantage of incorporating both mechanisms into a single system.

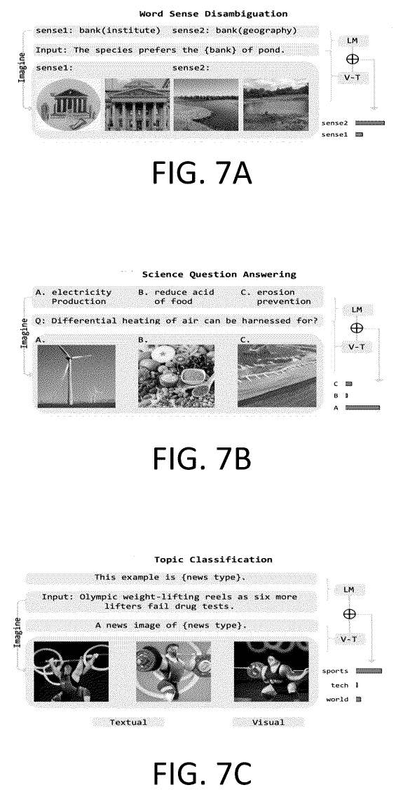

FIGS. 7A-7C demonstrate the Z-LaVI method solving three different exemplary task types: Word Sense Disambiguation, Science Question Answering, and Topic Classification.

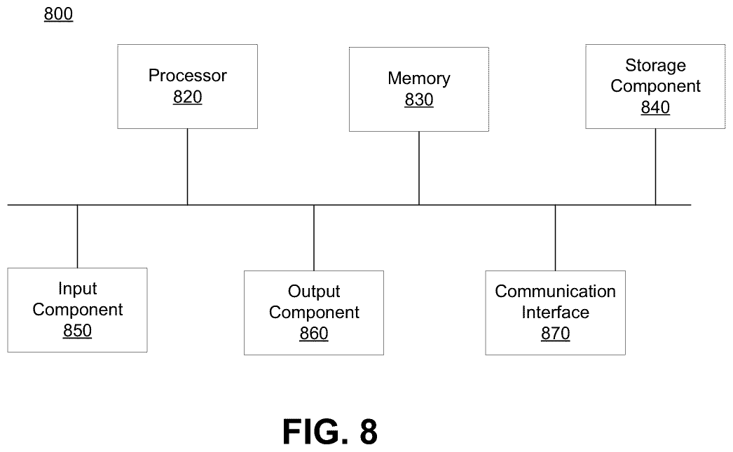

FIG. 8 is a block diagram of exemplary components of a device 800 in which methods, apparatuses, and systems described herein may be implemented, according to some embodiments. As shown in FIG. 8, the device 800 may include a bus 810, a processor 820, a memory 830, a storage component 840, an input component 850, an output component 860, and a communication interface 870.

The bus 810 includes a component that permits communication among the components of the device 800. The processor 820 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 820 includes one or more processors capable of being programmed to perform a function. The memory 830 includes a random access memory (RAM), a read-only memory (ROM), and/or another type of dynamic or static storage device (e.g., a flash memory, a magnetic memory, and/or an optical memory) that stores information and/or instructions for use by the processor 820.

The storage component 840 stores information and/or software related to the operation and use of the device 800. For example, the storage component 840 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 850 includes a component that permits the device 800 to receive information, such as via user input (e.g., a touchscreen display, a keyboard, a keypad, a mouse, a button, a switch, and/or a microphone). Additionally, or alternatively, the input component 850 may include a sensor for sensing information (e.g., a global positioning system (GPS) component, an accelerometer, a gyroscope, and/or an actuator). The output component 860 includes a component that provides output information from the device 800 (e.g., a display, a speaker, and/or one or more light-emitting diodes (LEDs)).

The communication interface 870 includes a transceiver-like component (e.g., a transceiver and/or a separate receiver and transmitter) that enables the device 800 to communicate with other devices, such as via a wired connection, a wireless connection, or a combination of wired and wireless connections. The communication interface 870 may permit the device 800 to receive information from another device and/or provide information to another device. For example, the communication interface 870 may include an Ethernet interface, an optical interface, a coaxial interface, an infrared interface, a radio frequency (RF) interface, a universal serial bus (USB) interface, a Wi-Fi interface, a cellular network interface, or the like.

The components of device 800 may be implemented in software instructions stored by a non-transitory computer-readable medium, such as the memory 830 and/or the storage component 840. A computer-readable medium is defined herein as a non-transitory memory device. A memory device includes memory space within a single physical storage device or distributed across multiple physical storage devices.

Software instructions may be read into the memory 830 and/or the storage component 840 from another computer-readable medium or from another device via the communication interface 870. When executed, software instructions stored in the memory 830 and/or the storage component 840 may cause the processor 820 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 8 are (e.g., a server cluster, edge devices, or a hybrid thereof). In a cloud-based embodiment, certain components (e.g., storage 840 and processing 820) may be provided as an example. In practice, the device 800 may include additional components, fewer components, different components, or differently arranged components than those shown in FIG. 8. Additionally, or alternatively, a set of components (e.g., one or more components) of the device 800 may perform one or more functions described as being performed by another set of components of the device 800.

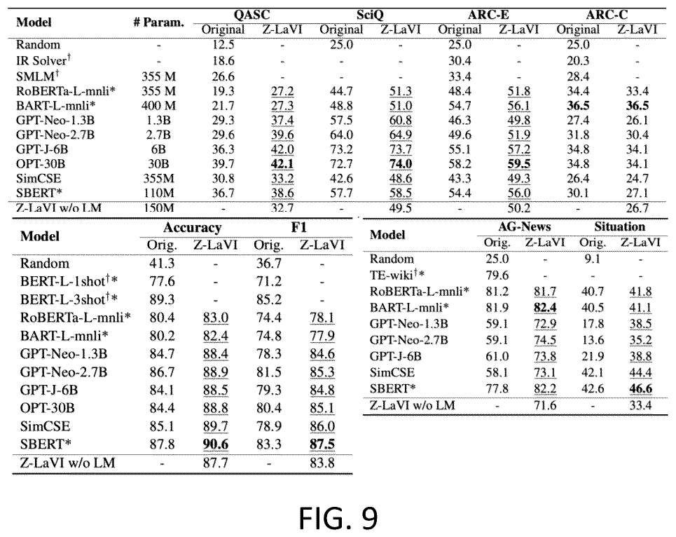

FIG. 9 illustrates the enhanced performance provided by one embodiment of the Z-LaVI system across a variety of datasets when compared to state-of-the-art natural language classifiers.

In some embodiments, the GPT-style and NLI-based language models described herein may be built on top of the Hugging Face API. In some embodiments, CLIP models described herein may use a ViT/B32 as an image encoder.

The techniques described above can be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the embodiments to the precise form disclosed. Modifications and variations are possible in light of the above disclosure or may be acquired from practice of the embodiments.

As used herein, the term component is intended to be broadly construed as hardware, firmware, or a combination of hardware and software.

Even though combinations of features are recited in the claims and/or disclosed in the specification, these combinations are not intended to limit the disclosure of possible embodiments. In fact, many of these features may be combined in ways not specifically recited in the claims and/or disclosed in the specification. Although each dependent claim listed below may directly depend on only one claim, the disclosure of possible embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The above disclosure also encompasses the embodiments listed below: A first method performed by at least one processor for processing language, the method comprising: receiving a first input stream of a task; receiving a second input stream of a solution; selecting the first input stream or the second input stream; providing the selected input stream to an image conversion model and a language model; creating, based on the selected input stream, a model ensemble of the image conversion model and the language model; and outputting a prediction based on the model ensemble.

The first method described above, wherein the language model uses a prompt based approach, and wherein the language model is a Generative Pre-Trained Transformer (GPT) model.

The first method described above, wherein the task is at least one of word sense disambiguation, science question answering, or text classification, wherein the prediction comprises at least one possible word sense of a target word based on the task being the word sense disambiguation; the prediction comprises an answer of a question based on the task being the science question answering, and the prediction comprises a category of text based on the task being the text classification.

A fourth method, including the first method, wherein the language model uses a Bidirectional Encoder Representations from Transforms (BERT).

The fourth method, wherein the language model uses a natural language inference approach.

The fourth method, wherein the language model uses a latent embedding approach.

The seventh method, including the first method, wherein the image conversion model uses a combined approach of recall and synthesis.

The seventh method, wherein the synthesis includes a text to image generation model.

The seventh method, wherein the synthesis includes a generative adversarial network.

The first method, wherein the model ensemble weights constituent models of the image conversion model and the language model based on a relative size of each constituent model.

A first apparatus comprising: at least one memory configured to store program code; and at least one processor configured to read the program code and operate as instructed by the program code, the program code comprising: receiving code configured to cause the at least one processor to receive a first input stream of a task and a second input stream of a solution, selecting code configured to cause the at least one processor to select the first input stream or the second input stream, providing code configured to cause the at least one processor to provide the selected input stream to an image conversion model and a language model, ensembling code configured to cause the at least one processor to create, based on the selected input stream, a model ensemble of the image conversion model and the language model, and outputting code configured to cause the at least one processor to output a prediction based on the model ensemble.

The first apparatus, wherein the language model uses a prompt based approach, and wherein the language model is a Generative Pre-Trained Transformer (GPT) model.

The first apparatus, wherein the task is at least one of word sense disambiguation, science question answering, or text classification, wherein the prediction comprises at least one possible word sense of a target word based on the task being the word sense disambiguation; the prediction comprises an answer of a question based on the task being the science question answering, and the prediction comprises a category of text based on the task being the text classification.

A fourth apparatus, including the first apparatus, wherein the language model uses a Bidirectional Encoder Representations from Transforms (BERT).

The fourth apparatus, wherein the language model uses a natural language inference approach or a latent embedding approach.

A sixth apparatus, including the first apparatus, wherein the image conversion model uses a combined approach of recall and synthesis.

The sixth apparatus, wherein the synthesis includes a text to image generation model.

The sixth apparatus, wherein the synthesis includes a generative adversarial network.

The first apparatus, wherein the model ensemble weights constituent models of the image conversion model and the language model based on a relative size of each constituent model.

A non-transitory computer readable medium having instructions stored therein, which when executed by a processor cause the processor to execute a method comprising: receiving a first input stream of a task; receiving a second input stream of a solution; selecting the first input stream or the second input stream; providing the selected input stream to an image conversion model and a language model; creating, based on the selected input stream, a model ensemble of the image conversion model and the language model; and outputting a prediction based on the model ensemble.

What is claimed is:

1. A language processing method performed by at least one processor, the language method comprising:
receiving a task input stream and a solution input stream;
selecting one of the task input stream and the solution input stream, and providing the selected stream to an image conversion model;
creating, based on the selected input stream, a model ensemble of the image conversion model and the language model;
and
outputting a prediction based on the model ensemble.

2. The language processing method of claim 1, wherein the language model uses a prompt based approach, wherein the language model is a Generative Pre-Trained Transformer (GPT) model, and wherein the creating the model ensemble comprises:
formatting the task input stream and candidate solutions of the solution input stream into a question-answer prompt to form input tuples (x, y), where x is the input task and y is a candidate solution;
providing the input tuples to the language model;
scoring the input tuples using the language model;
normalizing the scores across the candidate solutions using a softmax function; and
selecting one or more of the candidate solutions based on the normalized scores and incorporating the selected candidate solutions into the model ensemble.

3. The language processing method of claim 1, wherein the task is at least one of word sense disambiguation, science question answering, or text classification, and wherein the outputting the prediction comprises:
transforming the task input stream into a question;
associating the question with a plurality of candidate solutions obtained from the solution input stream to form a multi-choice formatted set of task-solution tuples;
providing the multi-choice formatted set of task-solution tuples to the language model for scoring;
normalizing the scores across the plurality of candidate solutions using a softmax function;
selecting, as a correct choice, one or more of the candidate solutions based on the normalized scores; and
incorporating the selected candidate solution or solutions into the model ensemble to generate the prediction,
wherein, based on the task being word sense disambiguation, the selected candidate solution comprises at least one word sense of a target word,
wherein, based on the task being science question answering, the selected candidate solution comprises at least one answer to the question, and
wherein, based on the task being text classification, the selected candidate solution comprises at least one category of text.

4. The language processing method of claim 1, wherein the language model uses Bidirectional Encoder Representations from Transformers (BERT),
wherein the providing the selected stream comprises:
receiving an input task from the task input stream together with candidate solutions obtained from the solution input stream to form task-solution tuples;
scoring each task-solution tuple based on a probability that the input task entails the candidate solution;
normalizing the probabilities across the candidate solutions using a softmax function; and
selecting one or more candidate solutions based on the normalized probabilities, and
wherein the creating the model ensemble comprises incorporating outputs of the language model generated from the selected candidate solutions together with outputs of the image conversion model.

5. The language processing method of claim 4, wherein the language model uses a natural language inference approach, and wherein the scoring comprises computing a probability that the input task entails the candidate solution.

6. The method of claim 4, wherein the language model uses a latent embedding approach,
wherein the providing the selected stream to the language model comprises:
encoding the task input stream and each candidate solution into a shared latent space;
determining a similarity score for each encoded task-solution pair;
normalizing the similarity scores across the candidate solutions using a softmax function; and
selecting one or more candidate solutions based on the normalized similarity scores, and
wherein the creating the model ensemble comprises incorporating outputs of the language model generated from the selected candidate solutions together with outputs of the image conversion model.

7. The language processing method of claim 1, wherein the image conversion model uses a combined approach of recall and synthesis, and wherein the providing the selected stream to the image conversion model comprises:
retrieving, by a recall engine, at least one preexisting image corresponding to the selected input stream;
generating, by a synthesis engine, at least one new image corresponding to the selected input stream;
forming a multimodal task using at least one of the retrieved image and the generated image;
scoring relevance between text of the selected input stream and at least one of the retrieved image and the generated image using a pre-trained vision-text model; and
creating the model ensemble by incorporating outputs of the image conversion model based on the multimodal task and the relevance scores together with outputs of the language model.

8. The method of claim 7, wherein the synthesis includes a text to image generation model, and wherein the creating the model ensemble comprises combining outputs of the text-to-image generation model with outputs of the language model.

9. The language processing method of claim 7, wherein the synthesis includes a generative adversarial network, and wherein the creating the model ensemble comprises combining outputs of the generative adversarial network with outputs of the language model.

10. The language processing method of claim 1, wherein the creating the model ensemble comprises weighting predictions of the image conversion model and the language model based on a relative size of each model, applying a sigmoid function to a ratio of parameter counts of the models to determine an ensemble weight, and summing the weighted predictions to form an output prediction.

11. A language processing apparatus comprising:
at least one memory configured to store program code; and
at least one processor configured to read the program code and operate as instructed by the program code, the program code comprising:
receiving code configured to cause the at least one processor to receive a task input stream and a solution input stream;
selecting code configured to cause the at least one processor to select one of the task input stream and the solution input stream;
providing code configured to cause the at least one processor to provide the selected input stream to an image conversion model and a language model;
ensembling code configured to cause the at least one processor to create, based on the selected input stream, a model ensemble of the image conversion model and the language model; and
outputting code configured to cause the at least one processor to output a prediction based on the model ensemble.

12. The language processing apparatus of claim 11, wherein the language model uses a prompt based approach, wherein the language model is a Generative Pre-Trained Transformer (GPT) model, and wherein the ensembling code is configured to cause at least one of the at least one processor to:
format the task input stream and candidate solutions of the solution input stream into a question-answer prompt to form input tuples (x, y), where x is the input task and y is a candidate solution;
provide the input tuples to the language model;
score the input tuples using the language model;
normalize the scores across the candidate solutions using a softmax function; and
select one or more of the candidate solutions based on the normalized scores and incorporate the selected candidate solutions into the model ensemble.

13. The language processing apparatus of claim 11, wherein the task is at least one of word sense disambiguation, science question answering, or text classification, and wherein the outputting code is configured to cause at least one of the at least one processor to:
transform the task input stream into a question;
associate the question with a plurality of candidate solutions obtained from the solution input stream to form a multi-choice formatted set of task-solution tuples;
provide the multi-choice formatted set of task-solution tuples to the language model for scoring;
normalize the scores across the plurality of candidate solutions using a softmax function;
select, as a correct choice, one or more of the candidate solutions based on the normalized scores; and
incorporate the selected candidate solution or solutions into the model ensemble to generate the prediction,
wherein, based on the task being word sense disambiguation, the selected candidate solution comprises at least one word sense of a target word,
wherein, based on the task being science question answering, the selected candidate solution comprises at least one answer to the question, and
wherein, based on the task being text classification, the selected candidate solution comprises at least one category of text.

14. The language processing apparatus of claim 11, wherein the language model uses Bidirectional Encoder Representations from Transformers (BERT),
wherein the providing code is configured to cause at least one of the at least one processor to:
receive an input task from the task input stream together with candidate solutions obtained from the solution input stream to form task-solution tuples;
score each task-solution tuple based on a probability that the input task entails the candidate solution;
normalize the probabilities across the candidate solutions using a softmax function; and
select one or more candidate solutions based on the normalized probabilities, and
wherein the ensembling code is configured to cause at least one of the at least one processor to create the model ensemble based on the language model, the selected candidate solutions, and the image conversion model.

15. The language processing apparatus of claim 14, wherein the language model uses a natural language inference approach or a latent embedding approach, and wherein the providing code is configured to cause at least one of the at least one processor to score each candidate solution by computing a probability that the input task entails the candidate solution.

16. The language processing apparatus of claim 14, wherein the language model uses a latent embedding approach,
wherein the providing code is configured to cause at least one of the at least one processor to:
encode the task input stream and each candidate solution into a shared latent space;
determine a similarity score for each encoded pair; and
select one or more candidate solutions based on the normalized similarity scores, and
wherein the ensembling code is configured to cause at least one of the at least one processor to create the model ensemble by incorporating outputs of the language model generated from the selected candidate solutions together with outputs of the image conversion model.

17. The language processing apparatus of claim 11, wherein the image conversion model uses a combined approach of recall and synthesis, and wherein the providing code is configured to cause at least one of the at least one processor to:
retrieve, by a recall engine, at least one preexisting image corresponding to the selected input stream;
generate, by a synthesis engine, at least one new image corresponding to the selected input stream;
form a multimodal task using at least one of the retrieved image and the generated image; and
provide the multimodal task to the image conversion model and incorporate outputs of the image conversion model together with outputs of the language model into the model ensemble.

18. The language processing apparatus of claim 17, wherein the synthesis includes a text-to-image generation model, and wherein the ensembling code is configured to cause at least one of the at least one processor to combine outputs of the text-to-image generation model with outputs of the language model.

19. The language processing apparatus of claim 17, wherein the synthesis includes a generative adversarial network, and wherein the ensembling code is configured to cause at least one of the at least one processor to combine outputs of the generative adversarial network with outputs of the language model.

20. A non-transitory computer readable medium having instructions stored therein, which when executed by a processor cause the processor to at least:
receive a task input stream and a solution input stream;
select one of the task input stream and the solution input stream;
provide the selected input stream to an image conversion model and a language model;
create, based on the selected input stream, a model ensemble of the image conversion model and the language model; and
output a prediction based on the model ensemble.
